(19) United States
(12) Patent Application Publication
(10) Pub. No.: US 2010/0071739 A1
(43) Pub. Date: Mar. 25, 2010

(54) PIN TYPE ONE POLE CRUTCHES

(76) Inventor: Kyungil Cho, Gyeonggi-do (KR)

Correspondence Address: CHRISTOPHER PAUL MITCHELL, 888 16TH ST., NW, SUITE 800, WASHINGTON, DC, 20006, US

(21) Appl. No.: 12/517,047

(22) PCT Filed: Jan. 10, 2008
(86) PCT No.: PCT/KR08/00157

§ 371 Date: May 29, 2009

(30) Foreign Application Priority Data
Jan. 12, 2007 (KR) 10-2007-0003815
Mar. 20, 2007 (KR) 10-2007-0026876
May 31, 2007 (KR) 10-2007-0053002
Aug. 7, 2007 (KR) 10-2007-0078880
Jan. 7, 2008 (KR) 10-2008-0001531

(51) Int. Cl. A61H 3/02

(52) U.S. Cl. 135/72

(57) ABSTRACT

Provided is a method of conveniently adjusting a height of a crutch that improves a conventional method of adjusting a length of a medical crutch and a height of a hand grip thereof. The conventional method of adjusting heights of a crutch including a armpit support 54 at an upper part thereof, a hand grip 11 at a middle part thereof, and a leg pole pipe 4 at a lower part thereof using a bolt, nuts, and a button is improved. A single fixing pin 21 installed inside a hand grip that is located in the middle part of a crutch is used to promptly adjust the height of the crutch including a side pole pipe 51 that is located in the upper part thereof and to which a armpit support 54 having armpit projections 54-1 at both ends thereof is attached, the hand grip 11, and a leg pole pipe 52 that is located in the lower part thereof. A steel reinforcing armature 100 is inserted into the leg pole pipe 52 that is S-curved, and a crutch rubber tip 53 is located in the centroid of the crutch. The leg pole pipe is inserted into the side pole pipe (a) or the leg pole pipe and the side pole pipe cross each other (b) to move both pipes up and down. The heights of the hand grip and the leg pole pipe of the pin type one pole crutch according to the present invention are adjusted using the single fixing pin, and the intensity of the steel reinforcing armature inserted into the leg pole pipe that is S-curved is increased.

### TECHNICAL FIELD

The present invention relates to a pair of pin type one pole crutches in which a side pole pipe 51 and a leg pole pipe 52 are in contact with each other and move up and down by inserting the leg pole pipe into the side pole pipe or crossing each other, and the leg pole pipe 52 into which a steel reinforcing armature 100 is inserted is S-curved, in order to adjust heights of a hand grip, the side pole pipe, and the leg pole pipe using single fixing pin 21.

### BACKGROUND ART

Referring to FIG. 2 that illustrates a pin type one pole crutch according to an embodiment of the present invention and a plurality of pairs of old type crutches, it is inconvenient to adjust heights of leg pole pipes and hand grips 11 of 3 bolt, 2 bolt, and button type crutches since the 3 and 2 bolt type crutches need to fasten and fix three or two wing nuts 1 to 3, and a hand grip of the button type crutches needs a bolt and a wing nut while a leg pole pipe of the button type crutches uses a button.

Referring to FIG. 3 that illustrates adjustable lengths of a pin type one pole crutch according to an embodiment of the present invention and a old type one pole crutch, although a side pole pipe 51 of the old type one pole crutch is S-curved to allow a crutch rubber tip 53 to be positioned in the centroid of the crutch, the crutch needs to additionally adjust heights of a hand grip 11 and a leg pole pipe 52 thereof, and an adjustable height a′ of the length pole pipe is insufficient for adjusting a height of the crutch itself. Thus, four sizes of crutches of extra large, large, medium, and small according to patients' heights must be manufactured, so that manufacturing factories or clinics are overstocked on those crutches, which is disadvantageous to the old type one pole crutch.

### BRIEF DESCRIPTION OF THE DRAWINGS

FIG. 1 is a perspective view of a whole structure of pin type one pole crutches according to an embodiment of the present invention;

FIG. 2 illustrates the pin type one pole crutches of the present invention and the old type crutches;

FIG. 3 illustrates the pin type one pole crutches of the present invention and the old type one pole crutches;

FIG. 4 illustrates a detached hand grip fixing pin of the pin type one pole crutches according to an embodiment of the present invention;

FIG. 5 illustrates a fixed hand grip fixing ping of the pin type one pole crutches according to an embodiment of the present invention;

FIG. 6 illustrates a spring fixing plate and its mold of the pin type one pole crutches according to an embodiment of the present invention;

FIG. 7 illustrates an adhered fixing pin plug of the pin type one pole crutches according to an embodiment of the present invention;

FIG. 8 illustrates a steel reinforcing armature and its mold of the pin type one pole crutches according to an embodiment of the present invention;

FIG. 9 illustrates the pin type one pole crutches according to an embodiment of the present invention; and

FIG. 10 illustrates pin type one pole crutches according to another embodiment of the present invention.

### DETAILED DESCRIPTION OF THE INVENTION

### Technical Goal of the Invention

The present invention provides a pair of pin type one pole crutches that adjust heights of a leg pole pipe 52 and a hand grip 11 using a single pin 21, which improves a conventional method of adjusting heights of a pair of crutches each including a armpit support 54 at an upper part thereof, a hand grip 11 at a middle part thereof, and a leg pole pipe 4 at a lower part thereof using a bolt, nuts, and a button.

### Disclosure of the Invention

According to an aspect of the present invention, there is provided a pair of pin type one pole crutches that move a hand grip 11 and a leg pole pipe 52 to a desired location, rotate 18-1 and forward 17-1 a rectangular plate 20 for fixing a fixing pin, insert the fixing pin into a pipe hole 55, and fix a height adjustment of a side pole pipe 51, the leg pole pipe 52, and the hand grip using the single fixing pin 21.

A spring fixing plate 24 that is inserted into the fixing pin 21 inside the hand grip is fixed to the fixing pin 21 using a mark of impression 26 for fixing a spring fixing plate. A fixing pin plug 12 is adhered to the hand grip 11 by fastening [symbol] -shaped pins 27 in a fastening groove 25.

The leg pole pipe 52 located in a lower part of the crutches is S-curved to install a crutch rubber tip 52 in the centroid of the crutches. A steel reinforcing armature 100 having C, D, I, O, and W cross-sections is inserted into the leg pole pipe formed of aluminum that is long and light and weak in view of the structure of the pin type one pole crutches.

The side pole pipe 51 and the leg pole pipe 52 cross each other using an upper plug 41, a hand grip plug 10, and a lower plug 31 each having a partition 49, 19, 39 formed in the middle thereof to move up and down without a friction there between.

Pipe grooves 51-1, 52-1 are vertically formed in the side pole pipe 51 and the leg pole pipe 52 inserted therein to prevent a rotation there between and the fixing pin hole 203 to move both pipes up and down in a predetermined direction, making it easier to insert the fixing pin.

Two armpit projections 54-1 that are symmetrically formed at both sides of an armpit support 54 are fixed under patient's armpit.

### Effect of the Invention

Heights of a hand grip and a leg pole of a pair of pin type one pole crutches can be adjusted using a single fixing pin plug having a rectangular fixing pin plug hole and a fixing pin having a rectangular plate for the fixing pin.

When a side pole pipe and a leg pole pipe cross each other and move up and down, an upper plug, a hand grip plug, and a lower plug each having a partition in the center thereof are used to prevent a friction between both pipes.

A spring fixing plate mounted in a fixing pin is easily fixed to the fixing pin using a mark of impression for fixing the spring fixing plate.

A fastening groove is formed at the end of the hand grip to fasten [symbol] -shaped pins for fixing a fixing pin plug in semi-circular fastening grooves by using a reference point when the [symbol] -shaped pins are fastened to the hand grip, in order to prevent the [symbol] -shaped pins from being hung by a patient's palm when the patient holds the hand grip.

A steel reinforcing armature is inserted into the leg pole pipe formed of aluminum that is long, light, and weak in view of the structure of the pin type one pole crutches, the leg pole pipe is S-curved, and a crutch rubber tip is formed in the centroid of the crutches, thereby increasing an adjustable height of the leg pole pipe.

Grooves are vertically formed in the side pole pipe and the leg pole pipe to prevent a rotation between both pipes and to allow a hole for inserting the fixing pin to move both pipes up and down, resulting in an easier insertion of the fixing pin.

Two armpit projections formed at both ends of a armpit support is under a patient's armpit so as to prevent the armpit support from slipping away from the patient's armpit.

### BEST MODE FOR CARRYING OUT THE INVENTION

A single fixing pin 21 installed inside a hand grip 11 that is located in the middle part of a crutch is used to promptly adjust the height of the crutch including a side pole pipe 51 that is located in the upper part thereof and to which a armpit support 54 having armpit projections 54-1 at both ends thereof is attached, the hand grip 11, and a leg pole pipe 52 that is located in the lower part thereof.

A steel reinforcing armature 100 is inserted into an empty space 101 inside the leg pole pipe 52 formed of aluminium that is light and weak, the leg pole pipe 52 is S-curved, and a crutch rubber tip 53 is located in the centroid of the crutch.

The present invention will now be described with reference to the accompanying drawings.

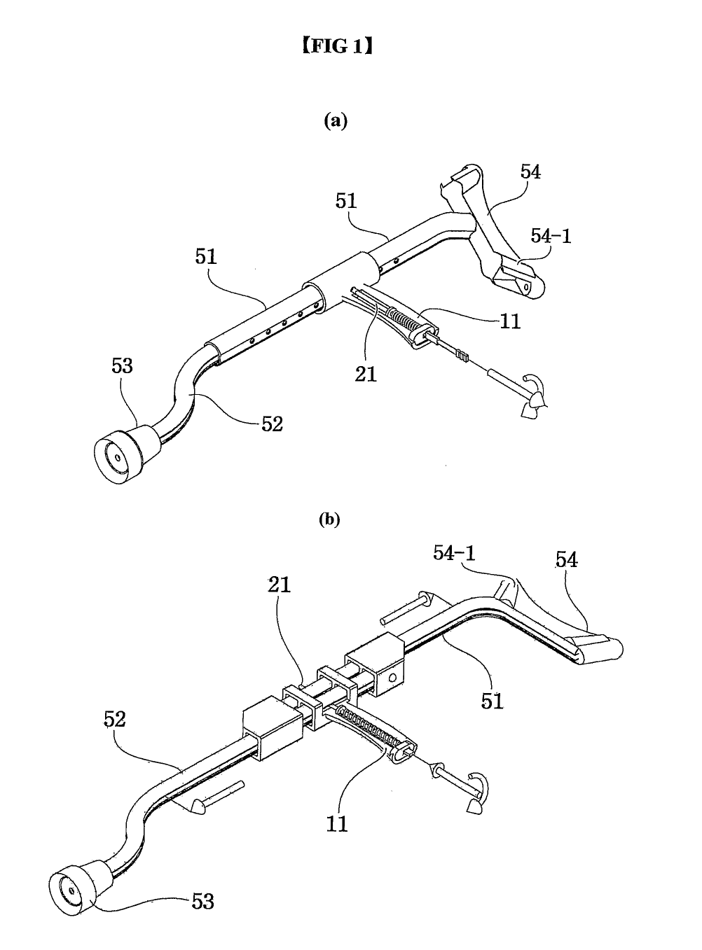

Referring to FIG. 1, the leg pole pipe is inserted into the side pole pipe (a) or the leg pole pipe and the side pole pipe cross each other (b) to move both pipes up and down. The hand grip 11, the leg pole pope 52, and the side pole pipe 51 are fixed using the single fixing pin 21.

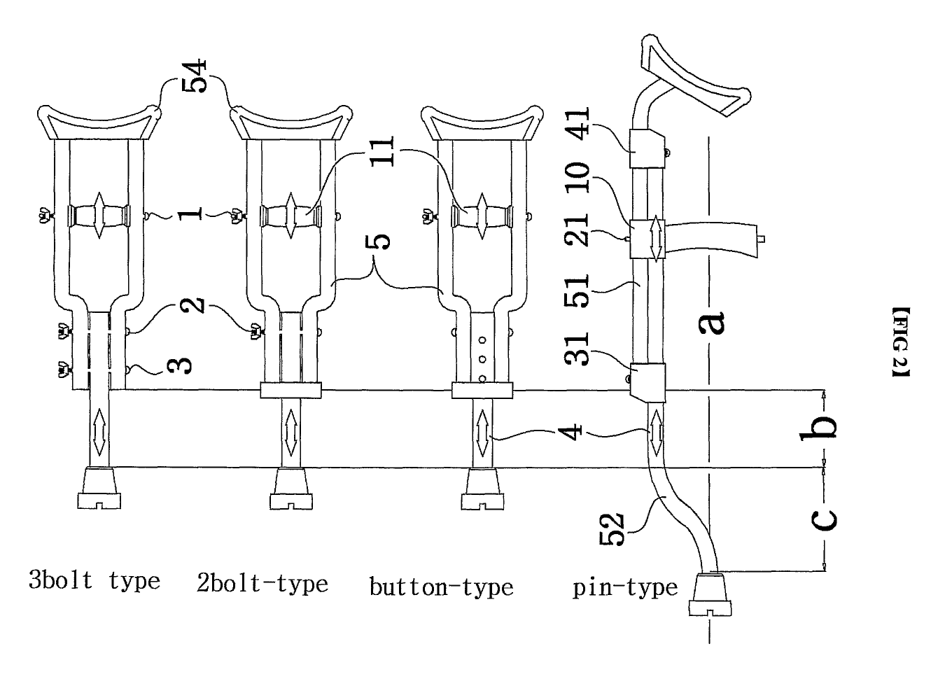

Referring to FIG. 2, a 3 bolt type crutch in which a bolt and a wing nut 1 are used to adjust the height of the hand grip 11, and two bolts and wing nuts 2, 3 are used to adjust the height of the leg pole pipe has been developed to a 2 bolt type crutch in which a bolt and the wing nut 1 are used to adjust the height of the hand grip, and a bolt and the wing nut 2 are used to adjust the height of the leg pole pipe.

Then, the 2 bolt type crutch has been developed to a button type crutch in which a bolt and a wing nut are used to adjust the height of the hand grip, and a button is used to adjust the height of the leg pole pipe.

In order to adjust the heights of the hand grip and the leg pole pipe 52 of the pin to type one pole crutch according to the present invention using the single fixing pin 21 installed in the hand grip, one of two side pole pipes 5 of the conventional crutch is removed and the other side pole pipe 51 and the leg pole pipe 52 are in contact with each other to move up and down and fix each other using the single fixing pin.

To install a crutch rubber tip in the centroid a of the crutch, the S-curved leg pole pipe 52 is fixed using the side pole pipe 51, an upper plug 41, a hand grip plug 10, and a lower plug 31 and moves up and down.

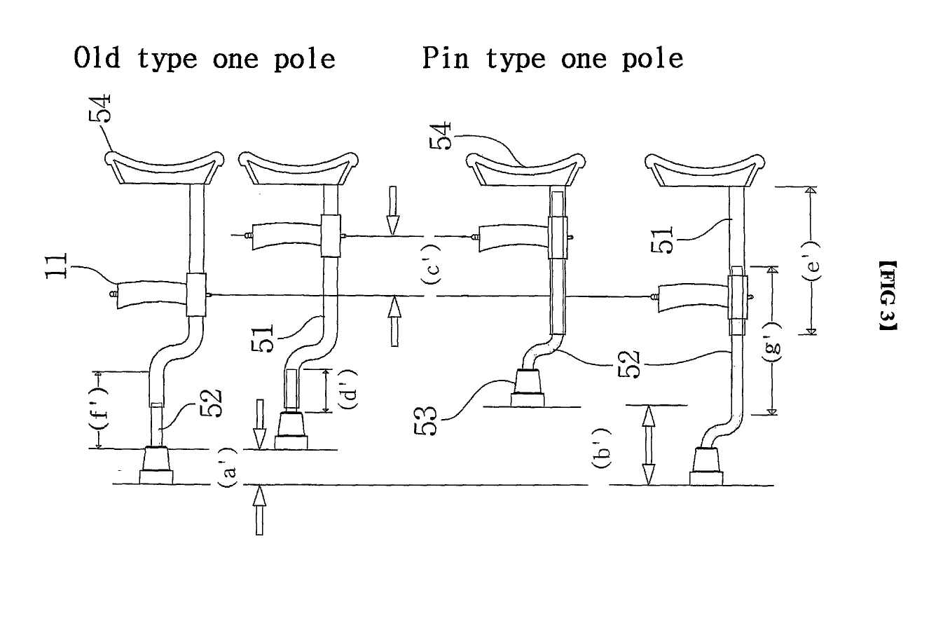

Referring to FIG. 3, the side pole pipe 51 of the old type one pole crutch is S-curved at a lower location of an adjustable maximum height c′ of the hand grip 11 and the leg pole pipe 52 thereof is inserted into the side pole pipe so that the crutch rubber tip 53 is located in the centroid of the crutch.

A straight distance f′ at the lower part of the S-curved side pole pipe 51 is equally divided to insert the leg pole pip 52 of one half distance d′ into the side pole pipe of the other half distance to move both pipes up and down.

Since the straight distance d′ and a movement distance of the leg pole pipe are short in view of the structure of the crutch, an adjustable height distance a′ of the leg pole pipe is also short, so that four sizes of extra large, large, medium, and small crutches must be manufactured and manufacturing companies and clinics are overstocked on those crutches.

Further, it is inconvenient to separately adjust the height of the hand grip 11.

Referring to FIG. 3, the leg pole pipe 52 of the pin type one pole crutch, which is S-curved at the lower location of an adjustable maximum height straight distance e′ of the hand grip 11 of the side pole pipe 51 and forms a maximum straight distance g′, is inserted into the side pole pipe, so that the crutch rubber tip 53 is installed in the centroid of the crutch.

In more detail, the side pole pipe that forms a maximum straight distance g′ obtained by subtracting the S-curved distance of the leg pole pipe from the minimum whole length of the crutch is installed.

The leg pole pipe that forms a maximum straight distance g′ at the S-curved upper part is inserted into the side pole pipe that forms the maximum straight line e′ and thus both pipes move up and down.

Since the maximum straight line e′ of the side pole pipe is long in view of the structure of the crutch, an adjustable height distance b′ of the leg pole pipe increases, so that two sizes of adults and children crutches according to patients' heights are manufactured, which reduces stocks of crutches of manufacturing factories and clinics.

Further, it is convenient that the heights of the hand grip 11 and the leg pole pipe can be simultaneously adjusted using the single fixing pin.

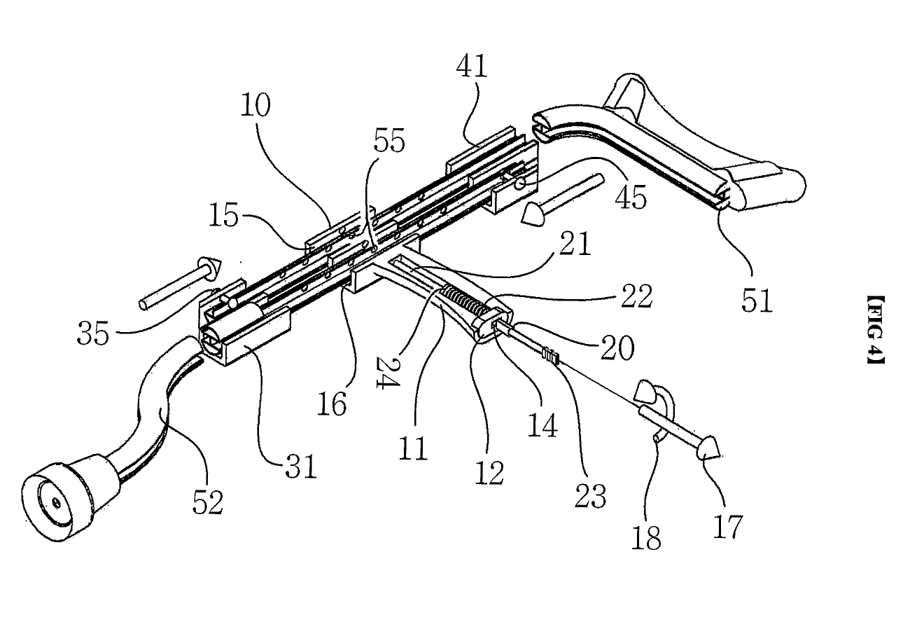

Referring to FIG. 4, a hand grip 23 of the fixing pin 21 pulls toward a forward direction 17 of the fixing pin in an arrow direction, and rotates 90 degrees in a rotation direction 18 of the fixing pin, so that a rectangular plate 20 for fixing the fixing pin is fixed to a rectangular fixing pin plug hole 14 at a right angle using an expansion force of a spring 22 and crosses the fixing pin plug hole 14.

In more detail, the hand grip 23 of the fixing pin pulls to move a spring fixing plate 24 to the forward direction 17 of the fixing pin in the arrow direction and contract the spring 22 so that the fixing pin 21 is not inserted into a pipe hole 55 for inserting the fixing pin of the side pole pipe and the leg pole pipe.

The hand grip 23 of the fixing pin rotates 90 degrees to allow the rectangular plate 20 for fixing the fixing pin to cross the rectangular hole 14 of the fixing pin plug in the shape of X and not be able to inserted into the hole 14 using the expansion force of the spring.

The side pole pipe 51 inside a moving path 15 of the side pole pipe of a hand plug 10 and a lower plug 31 that is coupled to the side pole pipe 51 using a rivet 35 for fixing the lower plug move to a desired location.

The leg pole pipe 52 inside a moving path 16 of the side pole pipe of the hand plug 10 and an upper plug 41 that is coupled to the leg pole pipe 52 via a rivet 45 for fixing the upper plug are moved to a desired location.

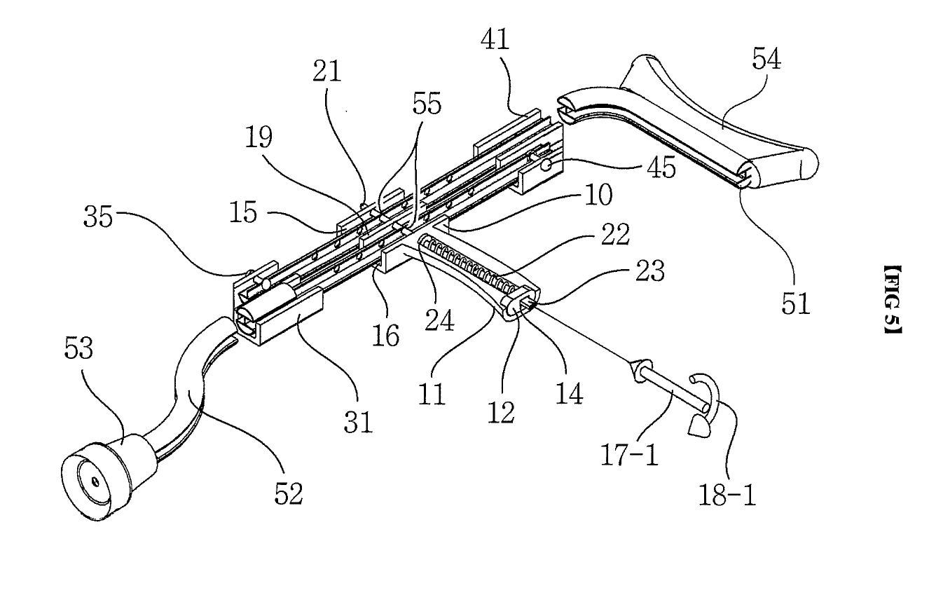

Referring to FIG. 5, the hand grip of the fixing pin rotates 90 degrees in a rotation direction 18-1 of the fixing pin to correspond the rectangular plate 20 for fixing the fixing pin to the rectangular hole 14 of the fixing pin plug and forward the fixing pin 21 in a forward direction 17-1 using the expansion force of the spring 22.

The fixing pin 21 is fixed to the hand grip 11 at a desired location by passing through the pipe hole 55 for inserting the fixing pin of the side pole pipe and the leg pole pipe and the hand grip plug partition 19.

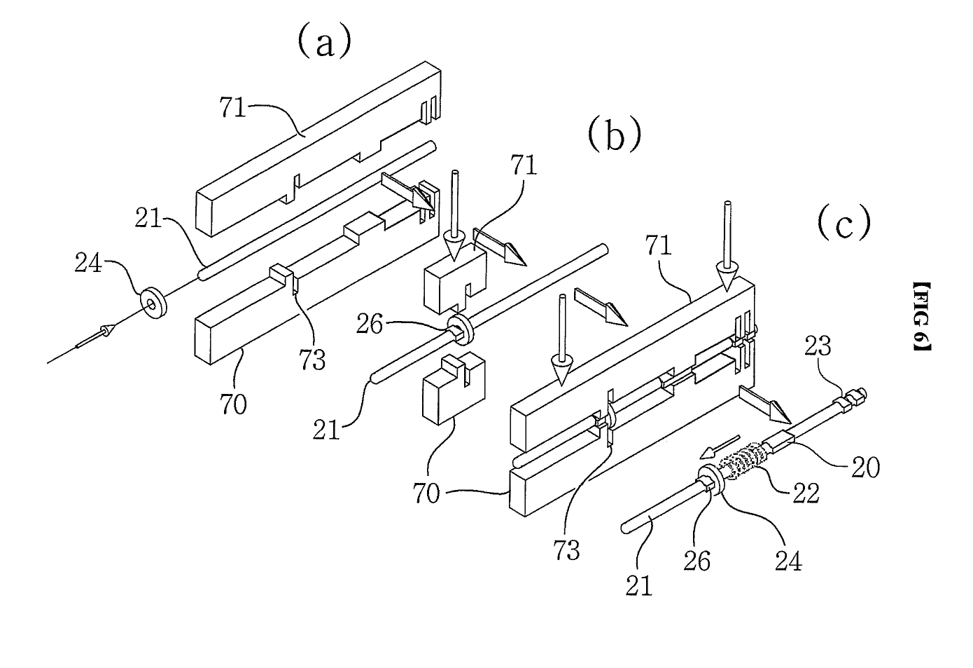

FIG. 6 illustrates a process of operating press machinery so as to form a mark of impression 26 for fixing the spring fixing plate for adhering the spring fixing plate 24 to the fixing pin 21, the rectangular plate 20 for fixing the fixing pin, and the hand grip 23 of the fixing pin.

Referring to FIG. 6a, the spring fixing pin 24 that is inserted into the fixing pin 21 is disposed between an upper mold 71 and a lower mold 70 of the power press machinery.

Referring to FIG. 6b, the upper mold is pressed and a projection for forming the mark of impression 26 for fixing the spring fixing plate installed in a mold of the power press machinery and projections for forming the rectangular plate 20 for fixing the fixing pin and the hand grip 23 of the fixing pin press the fixing pin 21 so that the fixing pin where the projections contact each other is widely spread by the pressure of the power press machinery.

Referring to FIG. 6c, the spring fixing plate 24 is installed between the rectangular mark of impression 26 for fixing the spring fixing plate and the rectangular plate 20 for fixing the fixing pin to allow the fixing pin 21 to move forward according to the expansion force of the spring 22.

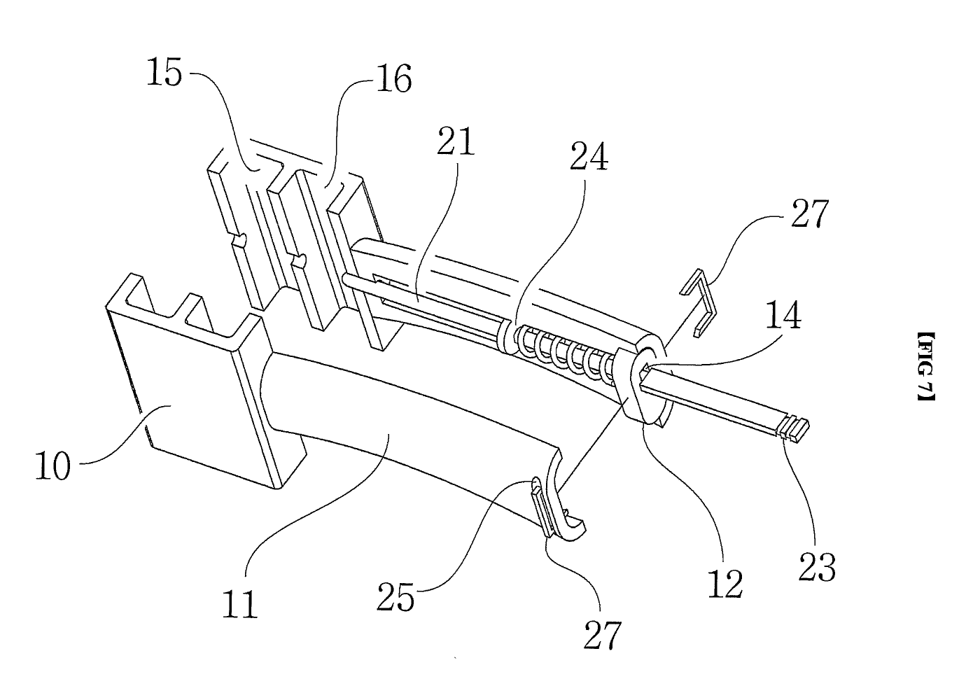

Referring to FIG. 7, [symbol] -shaped pins 27 installed in semi-circular fastening grooves 25 for the [symbol] -shaped pins that are located in both sides of the hand grip and formed up and down pass through the hand grip 11 and are fixed to the hand grip via the a fixing pin plug 12.

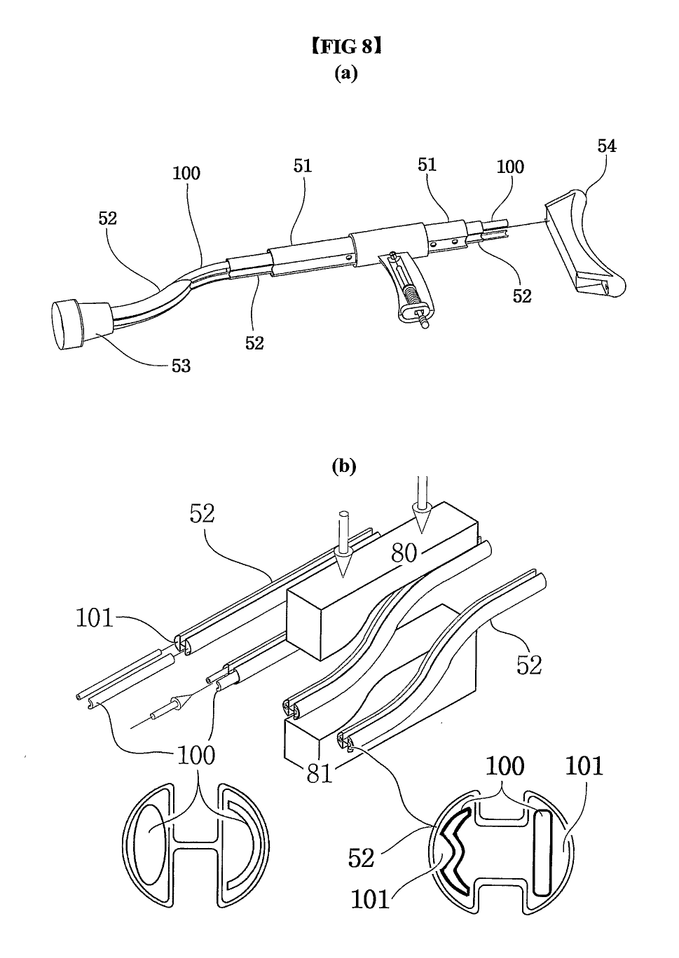

Referring to FIG. 8a, the steel reinforcing armature 100 is inserted into an empty space of both sides of the S-curved leg pole pipe 52, thereby increasing intensity of the leg pole pipe 52 that extends in view of the structure of the pin type one pole crutch.

Referring to FIG. 8b illustrating a process of inserting and bending the steel reinforcing armature 100 in the empty space 101 formed at both sides of the leg pole pipe 52, the steel reinforcing armature 100 having C, D, I, O, and W cross-sections is fully inserted into the empty space 101 formed at both sides of the leg pole pipe 52 formed of aluminum pipe that is light and weak, is pressed by bending presses 80, 81, and is fixed into the leg pole pipe 52 that is S-curved.

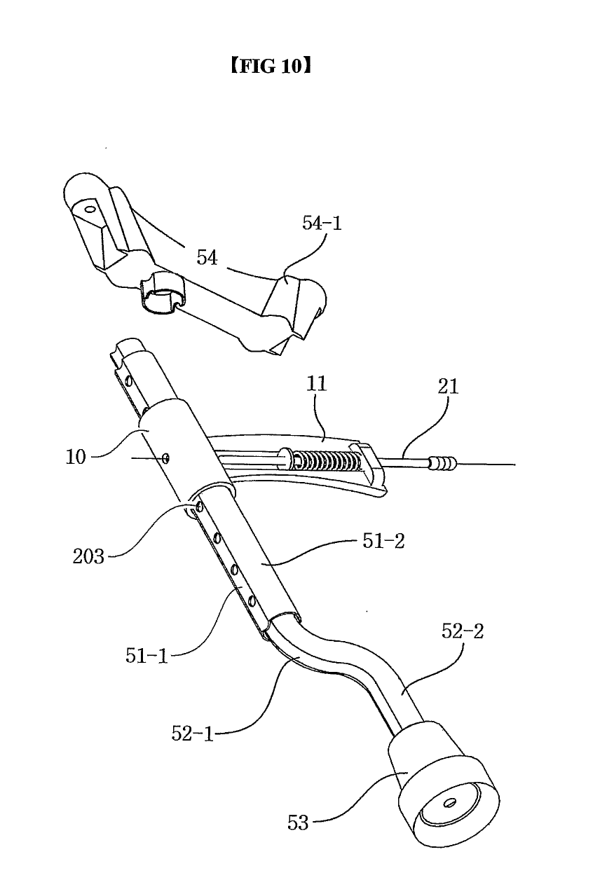

FIG. 10 illustrates a pin type one pole crutch including the leg pole pipe 52 that vertically forms a side pole pipe groove 51-1, a diameter of a side pole pipe projection 51-2 being smaller than a diameter of a large side pole pipe 51, and vertically forms a leg pole pipe groove 52-1 and a leg pole pipe projection 52-2 so that a hole 203 for inserting a side pole pipe fixing pin does not rotate but moves up and down, resulting in an easier insertion of the fixing pin 21.

### Embodiments

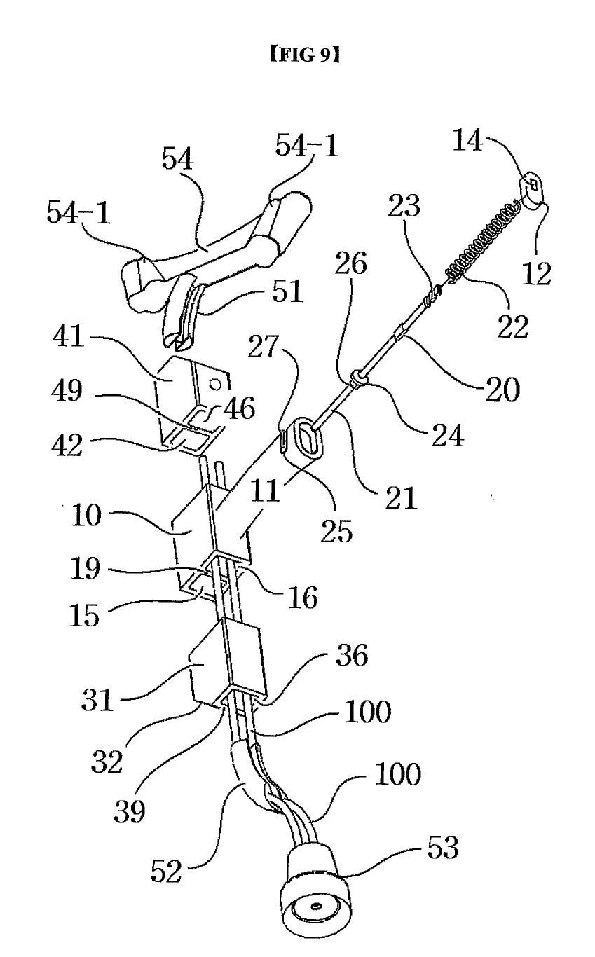

Referring to FIG. 9 that illustrates a pin type one pole crutch according to an embodiment of the present invention, the pin type one pole crutch comprises a armpit support 54 having armpit projections 54-1 symmetrically at both ends thereof, an upper plug 41 having an upper plug partition 49, a hand grip plug 10 having a hand grip plug partition 19, and a lower plug 31 having a lower plug partition 39, a fixing pint 21 that fixes a spring fixing plate 24 using a rectangular plate 20 for fixing the fixing pin and a mark of impression 26 for fixing the spring fixing plate, a fixing pin plug 12 having a rectangular fixing pin plug hole 14, a semi-circular fastening groove 25 for [symbol] -shaped pins with vertical grooves in order to prevent the [symbol] -shaped pins 27 installed in a hand grip 11 from being hung by a patient's palm, a steel reinforcing armature 100 having C, D, I, O, and W cross-sections inserted into the leg pole pipe 52 that is extended in view of the structure of the crutch, and the leg pole pipe 52 that is S-curved to allow a crutch rubber tip 53 to be located in the centroid of the crutch.

### INDUSTRIAL APPLICABILITY

A method of adjusting a height of a pair of pin type one pole crutches of the present invention makes it possible to easily and economically produce and sell crutches compared to the old type crutches.

### SEQUENCE LIST TEXT

1: bolt and wing nut for hand grip 2: bolt and wing nut for leg pole pipe 3: bolt and wing nut for leg pole pipe 4: arrow direction for leg pole pipe 5: side pole pipe 10: hand plug 11: hand grip 12: fixing pin plug 14: fixing pin plug hole 15: side pole pipe moving path for hand grip 16: leg pole pipe moving path for hand grip 17: arrow direction of fixing pin 18: rotation of fixing pin 17-1: arrow direction of fixing pin 18-1: rotation of fixing pin 19: hand grip plug partition 20: plate for fixing pin 21: fixing pin 22: spring 23: grip of fixing pin 24: spring fixing pleat 25: semi-circular fastening groove 26: mark of impression 27: [symbol] -shaped pin 31: lower plug 32: side pole pipe fixing groove 35: rivet for side pole pipe 36: leg pole pipe moving path 39: lower plug partition 41: upper plug 42: side pole pipe moving path 45: rivet for leg pole pipe 46: leg pole fixing groove 49: upper plug partition 51: side pole pipe 51-1: side pole pipe groove 51-2: side pole pipe projection 52: leg pole pipe 52-1: leg pole pipe groove 52-2: leg pole pipe projection 53: rubber tip 54: armpit support 54-1: armpit projection 55: pipe hole for fixing pin 70: lower mold 71: upper mold 80: upper mold 81: lower mold 100: steel reinforcing armature 101: empty space of leg pole pipe 203: hole

1. A pair of pin type one pole crutches, comprising:
a armpit support 54 that is located at an upper part of a crutch and has armpit projections 54-1 at both sides thereof being adhered to a side pole pipe 51, a leg pole pipe 52 and a side pole pipe crossing each other to move up and down by upper plug 41, hand plug 10 and lower plug 31 or the leg pole pipe inserted into the side pole pipe to move up and down;
a fixing pin 21 having a plate 20 for fixing a fixing pin 21, a spring 22, a spring fixing plate 24, and a mark of impression 26 for fixing the spring fixing plate inside a hand grip 11 of the crutch located in the middle thereof;
a fixing pin plug 12 fixed to the hand grip 11 of the crutch using [symbol] -shaped pins 27 installed in semi-circular fastening groove 25 for the [symbol] -shaped pins 27; and
the leg pole pipe 52 into which a steel reinforcing member armature 100 located in a lower part of the crutch is inserted being S-curved and a crutch rubber tip 53 installed in the centroid of the crutch.

2. The pair of pin type one pole crutches of claim 1, wherein the fixing pin 21 having a rectangular fixing pin plug hole 14, the spring 22, the spring fixing plate 24, and a rectangular plate 20 for fixing the fixing pin is installed inside the hand grip 11 of the crutch.

3. The pair of pin type one pole crutches of claim 2, wherein the mark of impression 26 for fixing the spring fixing plate 24 is installed in the fixing pin 21.

4. The pair of pin type one pole crutches of claim 2, wherein the [symbol] -shaped pins 27 and the semi-circular fastening groove 25 for the [symbol] -shaped pins 27 are installed to adhere the fixing pin plug 12 to the hand grip 11 of the crutch.

5. The pair of pin type one pole crutches of claim 1, further comprising:
an upper plug 41 having an upper plug partition 49 in the middle thereof, a side pole pipe moving path 42 and a leg pole pipe fixing groove 46, and coupled to the leg pole pipe using a rivet 45;
a hand plug 10 having a hand grip plug partition 19 in the middle thereof, and a side pole pipe moving path 15 and a leg pole pipe moving path 16; and
a lower plug 31 having a lower plug partition 39 in the middle thereof, a leg pole pipe moving path 36 and a side pole pipe fixing groove 32, and coupled to the side pole pipe using a rivet 35.

6. The pair of pin type one pole crutches of claim 1, wherein the S-curved leg pole pipe 52 is installed to allow the crutch rubber tip 53 to be located in the centroid of the crutch.

7. The pair of pin type one pole crutches of claim 6, wherein the steel reinforcing armature 100 having C, D, I, O, W cross-sections is inserted into an empty space 101 at both sides of the leg pole pipe 52.

8. The pair of pin type one pole crutches of claim 1, wherein the leg pole pipe 52 that vertically forms a leg pole pipe groove 52-1 and a leg pole pipe projection 52-2 is inserted into the side pole pipe 51 that vertically forms a side pole pipe groove 51-1 and a side pole pipe projection 51-2.

9. The pair of pin type one pole crutches of claim 1, wherein the armpit support 54 having the armpit projections 54-1 symmetrically at both sides thereof is installed in the crutch.
